(19) United States
(12) Patent Application Publication
(10) Pub. No.: US 2008/0121744 A1
(43) Pub. Date: May 29, 2008

(54) Frame Of A Movable Processing Device Of Mineral Materials, And A Multi-Purpose Fastening Device

(76) Inventors: Tero Jouko Juhani Majuri, Tampere (FI); Markku Armas Viitasalo, Tampere (FI)

Correspondence Address: OLIFF & BERRIDGE, PLC, P.O. BOX 320850, ALEXANDRIA, VA, 22320-4850, US

(21) Appl. No.: 11/666,917

(22) PCT Filed: Nov. 7, 2005
(86) PCT No.: PCT/FI05/50398

§ 371 Date: May 9, 2007

(30) Foreign Application Priority Data
Nov. 10, 2004 (FI) 200441449

(51) Int. Cl. B02C 21/02

(52) U.S. Cl. 241/101.77

(57) ABSTRACT

A frame of a movable processing device of mineral materials for supporting processing means of mineral materials, said frame comprising means for transferring the processing device of mineral materials. It is characterized in that the frame comprises a main frame and a multi-purpose fastening device attached turnably to the front end of the main frame, said multi-purpose fastening device being equipped with means for attaching detachably different accessory instruments of the processing device of mineral materials. The invention further concerns the multi-purpose fastening device.

### FIELD OF THE INVENTION

The present invention relates to movable processing devices of mineral materials. More precisely, the invention relates to the main frame of the processing devices and to a multi-purpose fastening device movably attached to the main frame, where different accessory instruments of the processing devices of mineral materials can be detachably attached.

Movable processing devices of mineral materials are well known in the art. These kinds of devices can include, among others, towed or self-propelled crushing machines, sieving machines, feeding machines and so forth.

It is also known in the art to equip a movable processing device of mineral materials with different accessory instruments, according to the need of processing in question for the mineral materials. Different applications, different materials to be handled and different working sites set different requirements to accessory instruments, which the manufacturers of the processing devices of mineral materials try to meet as good as possible.

In some cases the mineral material includes metals, whereby the processing device of mineral materials must be equipped with a magnetic separator that removes the magnetic metal parts from the mineral material already processed. This kind of a solution is described for example in the German patent publication DE 101 05 348 A1.

Sometimes it is necessary to move the processing device of mineral materials by towing it with some kind of a hauling apparatus, for example with a truck, whereby it is reasonable to equip the device with a tow bar and a standardized tow hitch connected thereto, to be adapted to the coupling part of the hauling apparatus when towing the device. This kind of a solution is described for example in the German patent publication DE 198 05 378 A1.

Sometimes the users of the processing devices of mineral materials have different needs concerning the distance and/or the height of the discharging level of the mineral material produced by the device, with respect to the processing device of the mineral materials. For this purpose it is known in the art to equip the processing device of the mineral materials with discharge conveyors of different length or with discharge conveyors having an adjustable position and angle of elevation. The subject is described for example in the international patent publication WO 02/092231 A1.

Sometimes it is necessary to separate the produced mineral material to different fractions based on the particle size thereof. For meeting this requirement, it is known to connect a sieving module to the processing device of mineral materials to the common movable main frame together with the rest of the processing device. This kind of a solution is disclosed for example in the German patent publication DE 101 05 348 A1.

Sometimes the dust separated from the mineral material by the handling of mineral materials can form environmental harms and health hazards to the people in the vicinity of the processing device of mineral materials. Some kind of a dust removal or dust suppressing system is required for the processing devices of mineral materials used in this kind of processes. Solutions known in the art are for example spraying of water to the mineral material for absorbing the dust and dust removing systems based on different exhausters and filters. Instruments required by both of the systems are in general attached to the main frame of the processing device of the mineral materials to be easily moved with the device. These kinds of solutions are disclosed for example in the English patent publication GB 2 357 049 A.

Especially the mineral material handled in large mineral quarries might be transported for a long way from the processing device of the mineral material. One alternative to implement this kind of transferring is to attach a chain of conveyors to the main frame of the processing device of mineral materials, turnably on vertical and horizontal level with respect to the main frame, comprised of sequential conveyors, by means of which the material is transferred. A solution of this kind is known for example from the European patent publication EP 0 573 255 B1.

In addition, easy portability is almost always required from a movable processing device of mineral materials, not only inside a single working site but also between separate working sites. Therefore it is in general required, that for the duration of the conveyance, the instruments of the processing devices are movable with respect to the main frame of the device in many different ways known in the art, so that the outer dimensions of the processing device can be minimized for the duration of the conveyance. Solutions aiming at this object are known for example from patent publications EP 1 110 625 A2, WO 98/46472 A1, WO 90/08720 A1, WO 2004/018106 A1 and FI 109662 B.

The strongly variable requirements for the standard of equipment and the requirement of portability have already for a long time represented a challenge to the manufacturers of the movable processing devices of mineral materials. Customized requirements can cause delivery specific engineering and alteration works to as such fixed technical basic solutions. This can still be implemented in a relatively simple way, in case it is not necessary to make other changes to the most important parts of the movable processing device of mineral materials, like to the main frame. Often these changes, however, must be made in order to guarantee the good service to the customer.

Especially the manufacturing encounters big challenges due to the tailoring, and especially, if the tailoring concerns the main frame of the movable processing device of mineral materials. Thereby the controllability of the production is more difficult. It is difficult to start the production before the final order from the customer, if you do not even know, what kind of a main frame the device must have when it is delivered. The main frame must naturally be available as first, when starting the final assembly of the device. When preparing to serve different customers in this situation flexibly and trying to adapt to different needs of the customers, the trough-put time of the production can even be lengthened. Attempts to shorten the trough-put time easily cause bigger stocks and more work in process (WIP), and thus more capital tied up in the production.

In general, almost all requirements for accessory instruments deviating from the standard product cause welding and other additional work, like for example repainting of welded points, to be performed in the stage of the final assembly, which is of cause not good from the point of view of the product quality.

A method known in the art, used by the manufacturing companies in order to meet the big amount of different requirements of the customers, is the mass tailoring, whereby the needs of different customers on the market should be anticipated as good as possible, the product should be designed modular so as to minimize the customer specific engineering work, and whereby the product can be assembled by the production exactly in accordance with the needs of the customer from sub-assembled modules that are ready designed, ready manufactured and that can be combined in different ways and are easily connectable to each other.

The modular construction of the product has in general proven to be good also after the commissioning of the devices. In changed operating conditions, in different working sites and with different materials to be processed, it is profitable, if different accessory instruments can be easily assembled to the movable processing device of mineral materials in order to be used in the changed conditions, also temporarily.

### SHORT DESCRIPTION OF THE INVENTION

For solving the problems of the technique of prior art it has now been invented a frame of a movable processing device of mineral materials in accordance with claim 1 and a multi-purpose fastening device in accordance with claim 6. In addition, preferred embodiments of the invention are disclosed in claims from 2 to 5 and from 7 to 8.

More precisely, the solutions in accordance with the present invention are characterized by what is stated in the characterizing part of claims 1 and 6.

Substantial for the present invention is, that the frame of the movable processing device of mineral materials is divided into two parts in the longitudinal direction thereof: a rigid main frame and a multi-purpose fastening device turnably attachable to the front end of the main frame, the position of said fastening device being changeable and different accessory instruments being attachable thereto. The multi-purpose fastening device, when attached immobile into the main frame, forms a part of the frame.

At least two or more of the following measures are implemented by means of the multi-purpose fastening device:
attachment and supporting of the discharge end of the discharge conveyor with respect to the main frame
adjustment of the angle of elevation of the discharge conveyor
attachment and supporting of an additional conveyor of the discharge conveyor with respect to the main frame
attachment and supporting of the sieving module with respect to the main frame
additional supporting of the conveyors of the sieving module with respect to the main frame
attachment and supporting of the tow bar with respect to the main frame
attachment and supporting of the magnet separator with respect of the main frame
attachment and supporting of the dust removal or dust suppressing device with respect to the main frame
attachment and support of the movable conveyor chain with respect to the main frame.

An advantage of the invention is that the movable processing device of mineral materials can be flexibly and safely equipped in connection with the final assembly and, if necessary, also after commissioning with several different accessory instruments by using the multi-purpose fastening device and without making any changes to the actual main frame of the device.

In this way the invention enables the manufacturer of the processing devices to start the assembly work related to the main frame based on one standard type of a main frame without having the final customized specification ready, and to finalize the assembly after the order of the customer according to the customized specification by equipping the multi-purpose fastening device quickly, as the last thing. This provides for a shorter through-put time of the manufacturing process of the device, a device varying according to versatile customer needs, and improves the product quality experienced by the customer, as well as decreases the amount of capital tied up in the manufacturing.

From the point of view of the customer, the invention provides better adaptability of the movable processing device of mineral materials to different working sites and different production processes. It is possible for the customer readily to change the movable processing device of mineral materials bought earlier, to be better adapted to the changed conditions, by buying and attaching different accessory instruments to the multi-purpose fastening device of the device.

In addition, the invention makes the changing of the movable processing device of mineral materials from the working position to the transport position and back, an operation safer than earlier.

### SHORT DESCRIPTION OF THE DRAWINGS

The invention will be described in more detail in the following based on preferred embodiments, with reference to the enclosed drawings, wherein:

FIG. 1 shows a side view of one movable processing device of mineral materials of prior art;

FIG. 2 shows a side view of another movable processing device of mineral materials of prior art equipped with a magnet separator, in working position;

FIG. 3 shows a side view of the movable processing device of mineral materials in accordance with FIG. 2, in the transport position;

FIG. 4 shows a side view of the transport arrangement of a movable processing device of mineral materials of FIG. 1;

FIG. 5 shows a side view of the transport arrangement of a third movable processing device of mineral materials of prior art;

FIG. 6 shows a side view of a fourth movable processing device of mineral materials of prior art;

FIG. 7 shows a top view of a sieving module of the movable processing device of mineral materials in accordance with FIG. 6;

FIG. 8 shows a side view of a multi-purpose fastening device of a movable processing device of mineral materials in accordance with the present invention in its upper position;

FIG. 9 shows a side view of the multi-purpose fastening device of the movable processing device of mineral materials in accordance with the present invention in its lower position;

FIG. 10 shows a side view of the multi-purpose fastening device of the movable processing device of mineral materials in accordance with the present invention equipped with a tow bar, in its upper position;

FIG. 11 shows a side view of the multi-purpose fastening device of the movable processing device of mineral materials in accordance with the present invention equipped with a tow bar, in its lower position;

FIG. 12 shows a side view the multi-purpose fastening device of the movable processing device of mineral materials in accordance with the present invention equipped with an additional conveyor;

FIG. 13 shows a side view the multi-purpose fastening device of the movable processing device of mineral materials in accordance with the present invention equipped with an additional conveyor, the additional conveyor being transferred;

FIG. 14 shows a side view of the multi-purpose fastening device of the movable processing device of mineral materials in accordance with the present invention equipped with a sieving module, in its upper position;

FIG. 15 shows a side view of the sieving module in accordance with FIG. 14;

FIG. 16 shows a side view of the multi-purpose fastening device of the movable processing device of mineral materials in accordance with the present invention equipped with a dust removal device, and

FIG. 17 shows a side view of the multi-purpose fastening device of the movable processing device of mineral materials in accordance with the present invention equipped with another kind of an additional conveyor or conveyor chain, showing a cross-sectional view of some parts so that the progressing of the mineral material in the device comes out better.

### DETAILED DESCRIPTION OF THE INVENTION

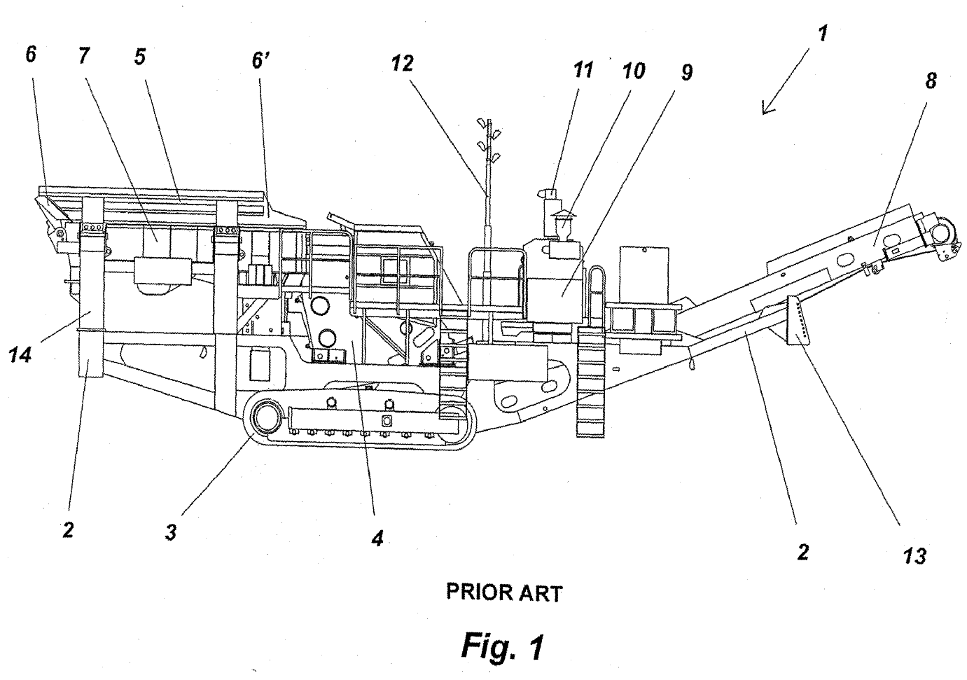

The main parts shown in FIGS. 1 to 17 are:
movable processing device of mineral materials 1
main frame 2
track assembly 3
crusher 4
feed hopper 5
side wall element of the feed hopper 6, 6′
feeder 7
discharge conveyor of processed material 8
power unit 9
air filter 10
exhaust pipe 11
lightning column 12
bracket of the discharge end of the discharge conveyor 13
feeder frame 14
magnet separator 20
bracket of the magnet separator 21
hangers of the magnet separator 22
hauling apparatus 30
carriage 31
hitch of the carriage 32
towing coupling of the hauling apparatus 33
tow bar 34
hitch of the tow bar 35
bogie 36
sieving module 40
frame of the sieving module 41
feeding trough of the sieving module 42
sieve 43
vibrating aggregate 44
support leg of the sieving module 45
support leg of the main frame 46
discharge conveyor of the sieving module 47
bracket of the discharge conveyor of the sieving module 48
hanger of the discharge conveyor of the sieving module 49
side conveyor of the sieving module 50
fastening element of the support leg of the sieving module 51
multi-purpose fastening device 60
supporting framework 61
means for attaching the supporting framework to the main frame, substantially turnably with respect to the main frame 62
means for locking the supporting framework to the main frame, substantially in mobile with respect to the main frame 63
means for attaching the hangers of the magnet separator 64, 64′
means for turning the supporting framework with respect to the main frame 65
tow bar 70
means for attaching the tow bar 71, 71′
hitch of the tow bar 72
additional conveyor 80
means for attaching the sieving module 90
operating support leg of the sieving module 91
means for attaching the multi-purpose fastening device 92
means for attaching the side conveyor of the sieving module 93
dust removal device 100
means for attaching the dust removal device 101, 101′
suction part of the dust removal device 102
funnel of the dust removal device 103
additional conveyor or a conveyor chain 110
bracket of the front end of the additional conveyor or the conveyor chain 111
means for attaching the bracket of the front end of the additional conveyor or the conveyor chain 112
frame part of the front end of the additional conveyor or the conveyor chain 113
hopper part of the bracket of the additional conveyor or the conveyor chain 114
processed mineral material 115
means for attaching the front end of the additional conveyor or the conveyor chain to the bracket of the additional conveyor or the conveyor chain 116
hinge 117.

In addition, the following denotations are used in the Figures:

the height of the movable processing device of mineral materials in the working position hₒ
the height of the movable processing device of mineral materials in the transport position hₜ
vertical axis of the hinge 117 aᵥ
horizontal axis of the hinge 117, transversal with respect to the additional conveyor or the conveyor chain aₕ.

FIG. 1 shows one movable processing device of mineral materials of prior art. The device is meant for reducing the particle size of the feed material by crushing. The main parts of the device are the feeder 7, the crusher 4 and the discharge conveyor 8 of the processed material, forming the processing means engaged in the processing of the mineral material in this case. The processing means is supported by the main frame 2.

In the device in accordance with FIG. 1, the mineral material is processed so that the feed material is fed for example by means of a digger or a wheel loader to the feed hopper 5. Below the open-bottom feed hopper there is located a feeder 7, in this example a vibratory feeder feeding the feed material as a steady flow into the crusher 4. The crusher reduces the particle size of the feed material, and the crushed material falls down from the crusher onto the discharge conveyor 8 transporting the crushed material out from the device 1 in front of the device.

Means for transferring the movable processing device 1 of mineral materials is attached below the main frame 2. In the device of the figure, these means are comprised of a track assembly 3 for moving the device 1 inside a single working site. The track assembly, as well as the processing means 7, 4, 8 of the device of the figure, is driven by the own power unit 9 of the device, which in the device of the figure is a diesel engine.

In the longitudinal direction, the main frame 2 of the device 1 extends as an integral welded construction from the feeder 7 far towards the discharge end of the discharge conveyor 8 supported by the part of the main frame most distant with respect to the feed end, the bracket 13 of the discharge end of the discharge conveyor. It is known in the art to divide the main frame in the vertical direction into two or more parts connected with each other detachably, like in FIG. 1, the main frame 2 itself and the feeder frame 14.

In this application the term “feed end” refers to that end of the device 1, where the material to be processed is fed to. This end is in this application also referred to as “tail end” (left in FIG. 1). Respectively, the end of the device, where the processed material is discharged is in this application referred to as “discharge end” or “front end” (right in FIG. 1). Respectively, when referring to conveyors in this application, the terms “feed end” and “discharge end” are used.

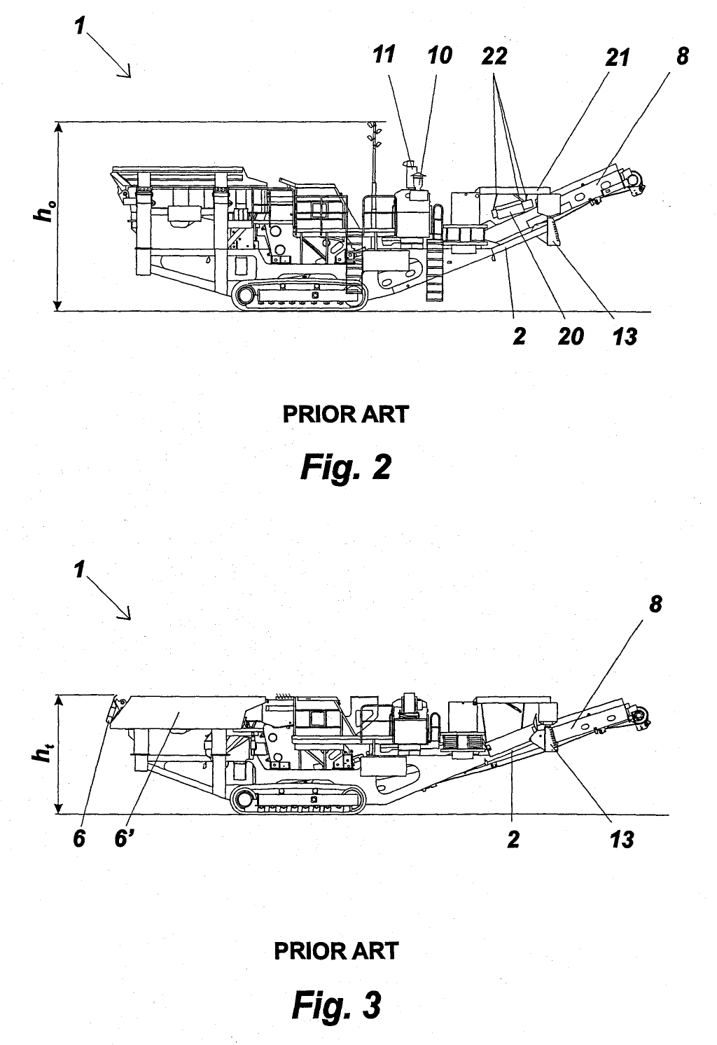

FIG. 2 shows another movable processing device 1 of mineral materials of prior art, equipped slightly in another way than the device of FIG. 1. A magnet separator 20 is mounted on top of the discharge conveyor 8, in the discharge end of the device, having the function of removing magnetic particles from the crushed mineral material. The magnet separator is needed, when the feed material to be processed is not pure mineral material but includes for example a mixture of rock materials and iron. This is the situation usually, when crushing pull down material of buildings for recycling, like for example concrete usually including reinforcing steel. The magnet separator 20 separates from the crushed concrete the reinforcing steels to the side of the device 1, and the crushed concrete is removed from the device through the discharge end of the discharge conveyor 8 to the front of the device.

So, the magnet separator 20 processes the crushed mineral material by removing impurities from it, being thus a processing means of mineral materials beside the feeder 7, the crusher 4 and the conveyor 8.

For mounting the magnet separator to the main frame 2 of the processing device of mineral materials, some small changes had to be designed and manufactured to the main frame 2 of the processing device 1. A bracket 21 of the magnet separator has been mounted immovably or detachably to the main frame, the magnet separator 20 being connected thereto by means of its hangers 22.

FIG. 2 shows the processing device of mineral materials in its working position. In FIG. 3, the same device is shown in its transport position. When moving inside the working site, the working height ho is usually not a problem. Instead, when transporting the device between separate working sites, the dimensions of the device must be below the maximum transportation dimensions defined by the legislation of the respective country or region. Therefore it is in general aimed to design the processing devices of mineral materials so, that they are readily and quickly changeable from the working position to the transport position for fulfilling the required transport dimensions.

When comparing the FIGS. 2 and 3, it can be seen, that several small changes had to be made when changing the device from the working position to the transport position. In order to improve the transportability, the feed hopper is in the devices of the figures designed to have multiple parts, so that is comprises side wall elements 6, 6′ hinged to the main frame, to be turned from the working position projecting upwards to the lower position for transportation. The parts that can be readily detached for the transportation, like the air filter 10 and the exhaust pipe 11 of the power unit, have been detached. Also the discharge end of the discharge conveyor 8 for the processed material has been lowered on its brackets 13. In this way the maximum height ht has been achieved, required by the transportation between the working sites, for example in the road transportation.

The brackets 13 are in general designed and manufactured so, that the angle of elevation of the discharge conveyor 8, and thus the maximum height of the discharge end can be adjusted as well with respect to the transportation as to the conditions on site in the best possible way, and locked into the desired position. The adjustment and setting of the angle of elevation of the discharge conveyor 8, however, is not an operation without risks. For adjusting the angle of elevation, the locking between the conveyor 8 and the bracket 13 must be opened for a short time during the adjustment, and the discharge end of the conveyor must be held up in some other way. The safest way to hold up the discharge end of the conveyor is to use an appropriate crane and hoisting devices. In the site conditions this kind of equipment is not always available, whereby the discharge end is in practice often supported by the bucket of a wheel loader or a digger. If the hold of the supporting device accidentally fails and the heavy conveyor falls down, there is the risk that people making the adjustment leave under the falling end of the conveyor.

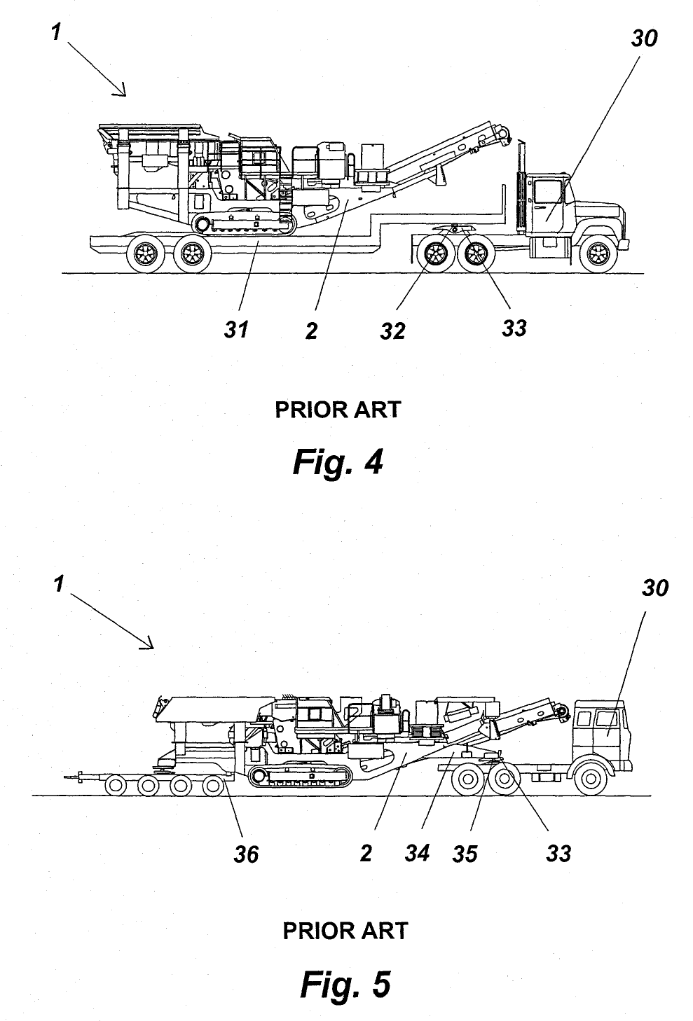

FIG. 4 shows one transportation arrangement of the movable processing device of mineral materials in accordance with FIG. 1. The device 1 has been driven with its own track assembly 3 onto a transportation carriage 31 driven by a hauling apparatus 30. The hauling apparatus 30 and the carriage 31 are coupled with each other with standardized coupling elements, to ensure the best possible compliance of an occasional carriage and an occasional hauling apparatus with each other. Usually the coupling elements are formed by a hitch 32 formed to the lower surface of the carriage and a suitable towing coupling 33 of the hauling apparatus.

The device 1 can be, as shown in FIG. 4, transferred quickly between different working sites towed by the hauling apparatus 30, in this case a truck.

FIG. 5 shows a transportation arrangement of a third movable processing device of mineral materials of prior art. In this case, no separate carriage is needed, but a tow bar 34 has been mounted immovably on the front end of the main frame 2 of the device 1, having a respective hitch 35, as used in the carriages. Thus, the main frame can be coupled to the towing coupling 33 of the hauling apparatus 30 in the corresponding way as the carriage. Fixed connecting elements have been formed to the tail end of the main frame 2 for coupling the main frame 2 to a bogie 36. When the main frame 2 of the device 1 is supported at its tail end by the bogie and at its front end by the hauling apparatus 30, the device 1 can be transferred as shown in FIG. 5 readily between different working sites driven by the hauling apparatus 30, in this case a truck. Means for transferring the movable processing device of mineral materials comprise in this case in addition to the track assembly 3, also the bogie 36 and the associated wheels.

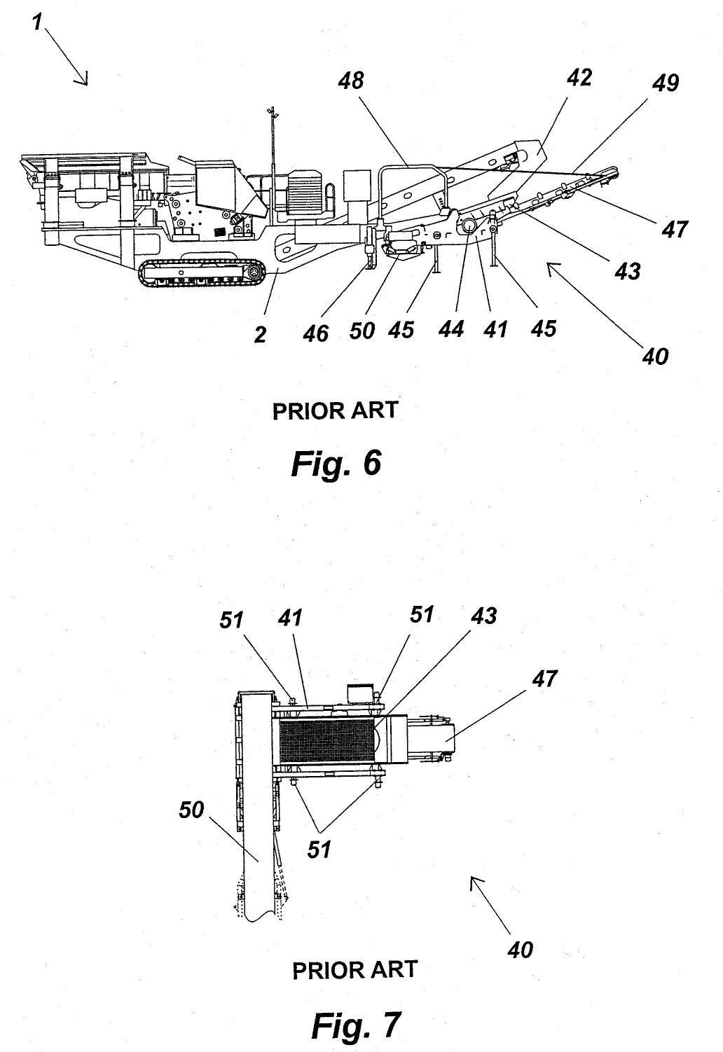

FIG. 6 shows a fourth movable processing device of mineral materials of prior art. In the device 1 shown in the figure, the device 1 has attaching elements mounted on the front end of the main frame 2, for the sieving module 40 attached detachably to the device 1, to be used, if necessary, for separating the processed mineral material in two different fractions based on the particle size. A feeding trough 42 of the sieving module is connected to the conveyor 8 having acted in the devices described above as a discharge conveyor of processed material, guiding the mineral material crushed in the crusher to the sieve 43 separating the mineral material to be produced into two fractions. The overflow of the sieve, in other words those particles that do not penetrate the sieve deck, are guided by the sieving module to the side conveyor 50 discharging the overflow beside the device 1. The underflow of the sieve, in other words those particles that penetrate the sieve deck, are guided by the sieving module to the discharge conveyor 47 discharging the underflow to the front of the device 1.

The sieve 43 of the sieving module 40 showing by FIG. 7 as a top view, is typically a so called vibrating screen being set into the frame 41 supported by springs (not shown), the vibration being produced by a vibrating aggregate 44. The vibration associated with the inclined position of the sieve makes the crushed mineral material to proceed along the sieve deck towards the side conveyor 50, at the same time, when the sieve deck discharges the underflow to penetrate onto the discharge conveyor 47.

Thus, the sieve 43 processes the mineral material by separating it into fractions, based on the particle size, and the conveyors 47, 50 transport the fractions away from the device 1. Thus, the sieve 43 and the conveyors 47, 50 are processing means of mineral material besides the feeder 7, the crusher 4 and the conveyor 8.

The sieving module 40 is a quite heavy accessory instrument. The mounting thereof to the main frame 2 requires in general different additional bracings (not shown) to the main frame. Usually attaching elements (not shown) must be formed to the main frame, to attach the respective attachments (not shown) of the sieving module. Alternatively, the frame 41 of the sieving module 40 can be mounted to the main frame 2 also as fixed equipment by welding, but in that case the device 1 is not as well suitable for alternating purposes of use. An extra support leg 46 must in general be mounted on the main frame 2 to support the weight of the sieving module. The length of the support leg 46 is exactly adjustable to an appropriate length to support the main frame 2 of the device 1 at the front end of the main frame under the prevailing circumstances on the site. Often the length of the support leg is hydraulically adjustable. In general, also a bracket 48 for the discharge conveyor 47 of the sieving module must be formed to the main frame, to which the discharge end of the discharge conveyor is supported by means of a hanger 49. Also the side conveyor 50 can require this kind of a bracket 48 and its own hanger (not shown).

Also the own support legs 45 of the sieving module are in general attached detachably by means of their own fastening elements 51 to the frame 41 of the sieving modules 40 that can be mounted detachably to the main frame 2, the sieving module being able to stand supported by them, when it is not attached to the main frame 2. The length of these support legs is in general adjustable for making the detaching and attaching of the sieving module 40 to the main frame 2 easier. The support legs are usually also mounted either with hinges or detachably to the frame 41 of the sieving module, so as not to impede the transferring of the device 1.

Common for the movable processing devices of mineral materials of prior art of FIGS. 1 to 6 is that the main frame 2 of the device 1 extends in the longitudinal direction as an integral, rigid construction from the feed end of the device far towards the discharge end of the device 8, where is located, viewed from the feed end of the device, the most distant part of the main frame, being usually the bracket 13 of the discharge end of the discharge conveyor. The main frame is in general a welded construction, but it can also be assembled for example by riveting or bolt connections.

Associated with all different movable processing devices of mineral materials of prior art is the problem, that the accessory instruments 20, 34, 40 connected thereto require different additional properties from the main frame 2. This is a problem from the point of view of the manufacturing process of the devices, as stated in the description of the background of the invention. In addition, the different modification operations of the movable processing device of mineral materials of prior art described above, to be performed on the working site, are difficult and often even dangerous, because they are associated with lifting, supporting and transferring of heavy loads in often difficult climate and terrain conditions of working sites.

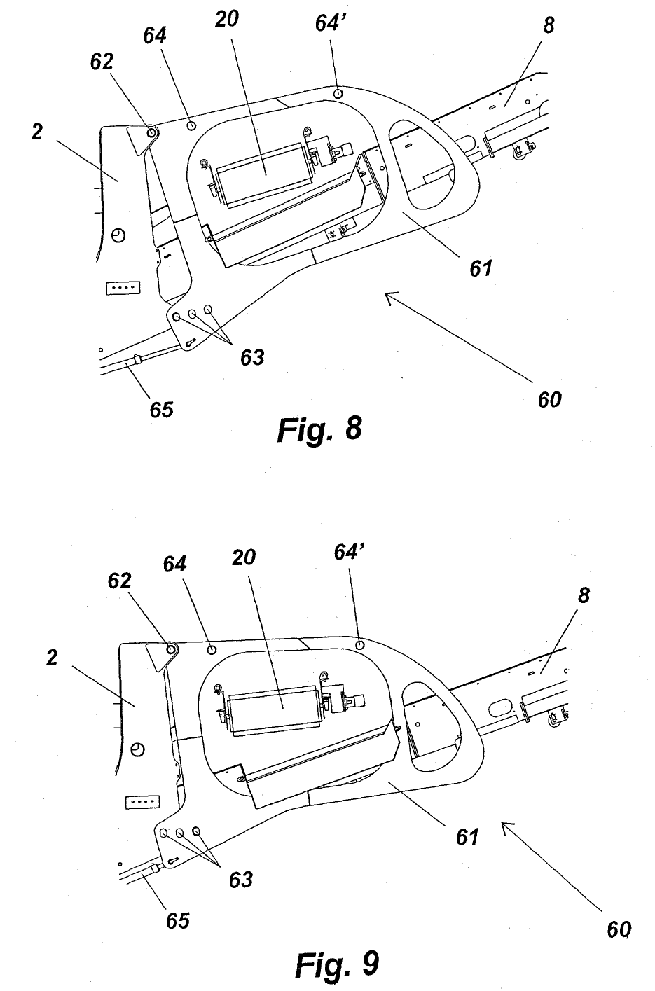

FIGS. 8 to 17 show a multi-purpose fastening device 60 of a movable processing device 1 of mineral materials in accordance with the present invention. The multi-purpose fastening device is substantially comprised of a supporting framework 61, attaching means 64, 64′, 71, 71′, 90, 101, 101′, 112 for different accessory instruments, means 62 for attaching the supporting framework 61 to the main frame 2 turnably with respect to the main frame, as well as means 63 for locking the supporting framework 61 to the main frame 2, substantially immobile with respect to the main frame 2, whereby the multi-purpose fastening device 60 forms an extension of the main frame 2, as a part of the frame. Preferably the supporting framework of the multi-purpose fastening device can be locked in several different positions with respect to the main frame. In an advantageous embodiment, the multi-purpose fastening device 60 further comprises means 65 for turning the supporting framework 61 about the horizontal axis perpendicular to the longitudinal centre axis of the main frame 2.

FIG. 8 shows a side view of a multi-purpose fastening device 60 of a movable processing device of mineral materials in accordance with the present invention in its upper position. The upper position here means that the means 63 for locking the supporting framework 61 to the main frame 2 substantially immobile with respect to the main frame is adjusted so, that the supporting framework 61 has turned around the hinge 62 (in the figure counter-clockwise) relatively high.

FIG. 9 shows a side view of a multi-purpose fastening device 60 of FIG. 8 of a movable processing device of mineral materials in its lower position. The lower position here means that the means 63 for locking the supporting framework 61 to the main frame 2 substantially immobile with respect to the main frame is adjusted so, that the supporting framework 61 has turned around the hinge 62 (in the figure clockwise) relatively low.

In this application, the terms “lower position” and “upper position” describing the relative position between the supporting framework 61 and the main frame 2 are not limited to include only the extreme relative positions between the supporting framework 61 and the main frame, nor any certain absolute angles evaluated as degrees. What in each individual situation is meant by “upper position” and “lower position” is defined based on the appropriateness. In this application, the term “lower position” in connection with the respective position between the supporting framework 61 and the main frame 2 refers to the proportionally lower position with respect to the upper position, and the term “upper position” refers to the proportionally upper position with respect to the lower position.

In the embodiments of the invention shown in FIGS. 8 and 9, means 64, 64′ are formed into the supporting framework 61 for attaching a magnet separator 20 by using hangers (not shown). Means 64, 64′ for attaching the magnet separator 20 to the supporting framework 61 are in the most simple way comprised by apertures formed into the supporting framework, through which an axle is extending through the hangers of the magnet separator and the support framework, or two shorter axle stubs, each extending through one hanger of the magnet separator and one half of the supporting framework, respectively. Naturally the axle and the axle stubs can preferably be locked in place laterally. Means 64, 64′ can naturally also be other kinds of fastening means known in the art, like for example a bolt and nut combination.

Further, the supporting framework in accordance with FIGS. 8 and 9 includes means (not shown) for supporting the discharging end of the discharge conveyor 8. This kind of a support can be in the most simple way a transverse beam, pipe or bar, the conveyor 8 resting thereon self-supported. It is substantial that the supporting means of the discharge end of the conveyor allows the longitudinal motion of the conveyor with respect to the supporting means. This is because when turning the supporting framework 61 with respect to the main frame 2, the supporting means of the discharge end of the conveyor 8 sets to a different place of the conveyor. In a preferred embodiment, the supporting means of the discharge end of the conveyor is a roll supported with bearings to the transverse beam, pipe or bar, on which the conveyor 8 easily glides with respect to the supporting framework.

Preferably the supporting means of the discharge end of the conveyor prevent the conveyor from jumping with respect to the supporting framework for example when moving the processing device 1 of mineral materials on an uneven ground. Thus, the supporting means of the discharge end of the conveyor 8 are preferably formed by rolls located on two levels, between which the conveyor or the guide formed to the body of the conveyor can slide easily with respect to the supporting framework 61. The supporting framework 61 can be dimensioned so that it prevents the lateral movement of the conveyor 8.

Means 65 for turning the supporting framework with respect to the main frame are preferably formed of a hydraulic cylinder attached at its one end to the main frame 2 turnably with respect to the main frame, and at its other end to the supporting framework 61 turnably with respect to the supporting framework. The driving power for the hydraulic cylinder can be supplied from an external pressure source. Preferably the hydraulic cylinder is, however, supplied by the own hydraulic system of the movable processing device 1 of mineral materials and it is controlled with the own control system of the movable processing device 1 of mineral materials.

Means 62 for attaching the supporting framework 61 to the main frame 2 turnably are in the most simple way formed of apertures formed into the main frame and the supporting framework, through which an axle is extending through the main frame and the supporting framework, or two shorter axle stubs, each extending through one half of the main frame and one half of the supporting framework, respectively. Naturally the axle and the axle stubs are preferably locked in place laterally. Correspondingly, means 63 for locking the supporting framework 61 to the main frame 2 substantially immobile with respect to the main frame are formed in the most simple way of apertures formed in the main frame and the supporting framework, through which an axle is extending through the main frame and the supporting framework, or two shorter axle stubs, each extending through one half of the main frame and one half of the supporting framework, respectively. Naturally the axle and the axle stubs are preferably locked in place laterally.

Also be other kinds of fastening and locking means 62, 63 known in the art can be used, like for example a traditional bolt and nut combination.

Changing of the conveyor 8 and the supporting framework of the movable processing device 1 of mineral materials of FIGS. 8 and 9 from the working position to the transport position and back happens easily and safely by means of the multi-purpose fastening device 60 without an external hoisting device. The mass of the conveyor 8 and the supporting framework 61 rests the whole time during the change on the fastening means 62 and there is no risk that they fall. The changing happens by loosening the locking means 63, by turning the supporting framework to the desired position with respect to the main frame around the means 62, and by fastening the means 63 again. Preferably the turning of the supporting framework is performed with means 65, but it can also be implemented by means of some external tool, like for example a crane.

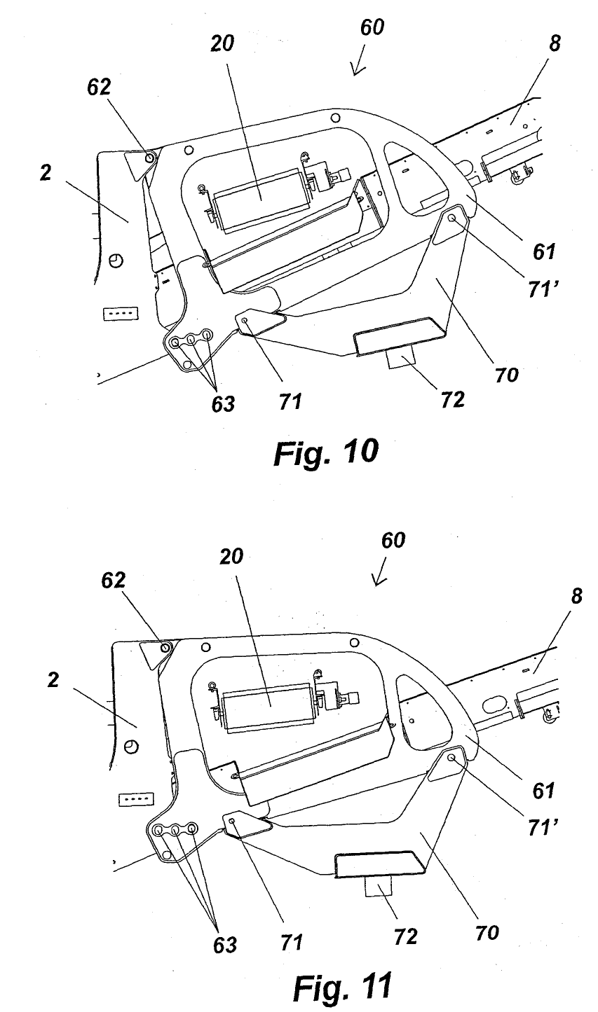

FIGS. 10 and 11 show the multi-purpose fastening device 60 of a movable processing device of mineral materials in accordance with the present invention equipped with a tow bar 70 and means 71, 71′ for attaching the tow bar. Means 71, 71′ for attaching the tow bar 70 to the supporting framework 61 are in the most simple way formed of apertures formed into the tow bar and the supporting framework, through which an axle is extending through the tow bar and the supporting framework, or two shorter axle stubs, each extending through one half of the tow bar and one half of the supporting framework, respectively. Naturally the axle and the axle stubs are preferably locked in place laterally. Means 71, 71′ can naturally also be other kinds of fastening means known in the art, like for example a bolt and nut combination.

Fastening of the movable processing device 1 of mineral materials to the hauling apparatus 30 is provided so, that when the multi-purpose fastening device is in its upper position, either the processing device 1 of mineral materials is moved into the vicinity of the hauling apparatus 30, or vice versa, so that the hitch 72 of the tow bar 70 sets above the towing coupling 33 of the hauling apparatus, and the multi-purpose fastening device is lowered to its lower position so, that the hitch 72 and the towing coupling 33 are interconnected, after which the supporting framework 61 is locked with respect to the main frame 2 substantially immobile by means of the locking means 63. Correspondingly, the detaching of the movable processing device 1 of mineral materials from the hauling apparatus 30 is provided so, that when the multi-purpose fastening device is in its lower position, the locking means 63 is detached, the multi-purpose fastening device is lifted to its upper position, the supporting framework 61 is locked by means of the locking means 63 substantially immobile with respect to the main frame 2, and either the processing device 1 of mineral materials is moved away from the hauling apparatus 30, or vice versa. At the same time, the conveyor 8 sets by means of the multi-purpose fastening device automatically to the transport position for transportation and to the working position in order to process the mineral materials.

FIGS. 10 and 11 show, in addition to the towing bar mentioned above, also the magnet separator 20 fastened to the multi-purpose fastening device.

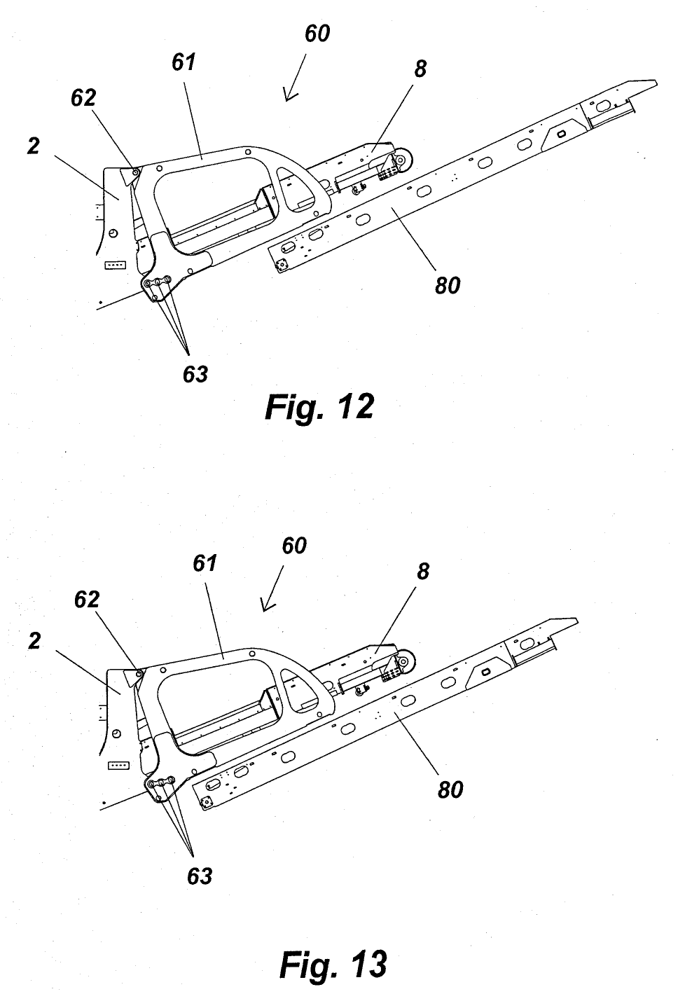

The embodiments of FIGS. 12 and 13 show a side view of a multi-purpose fastening device 60 of a movable processing device of mineral materials in accordance with the invention, equipped with an additional conveyor 80. Means (not shown) for fastening the supporting framework 61 and the frame of the additional conveyor 80 are formed to the same for fastening them to each other. In the most simple way, this means is formed by apertures extending through the supporting framework 61 or a part thereof and through the frame of the conveyor 80 or a part thereof, and by bolt and nut combinations to be put into these apertures, or by axles or axle stubs described in connection with the description of FIGS. 8 to 11. Also other fastening methods know in the art can be used for attaching the additional conveyor 80 and the supporting framework 61 detachably to each other.

Use of a detachable additional conveyor provides the advantage, that in operations, where the processed mineral material must be discharged upper or further from the processing device of mineral material, this can be made easily by mounting an additional conveyor 80 on the device. An alternative is to replace the discharge conveyor 8 itself by a longer discharge conveyor, or by some other more complicated arrangement.

Preferably the means for fastening the additional conveyor 80 to the supporting framework 61 enables the fastening of the additional conveyor at least in two different positions, as shown in FIGS. 12 and 13.

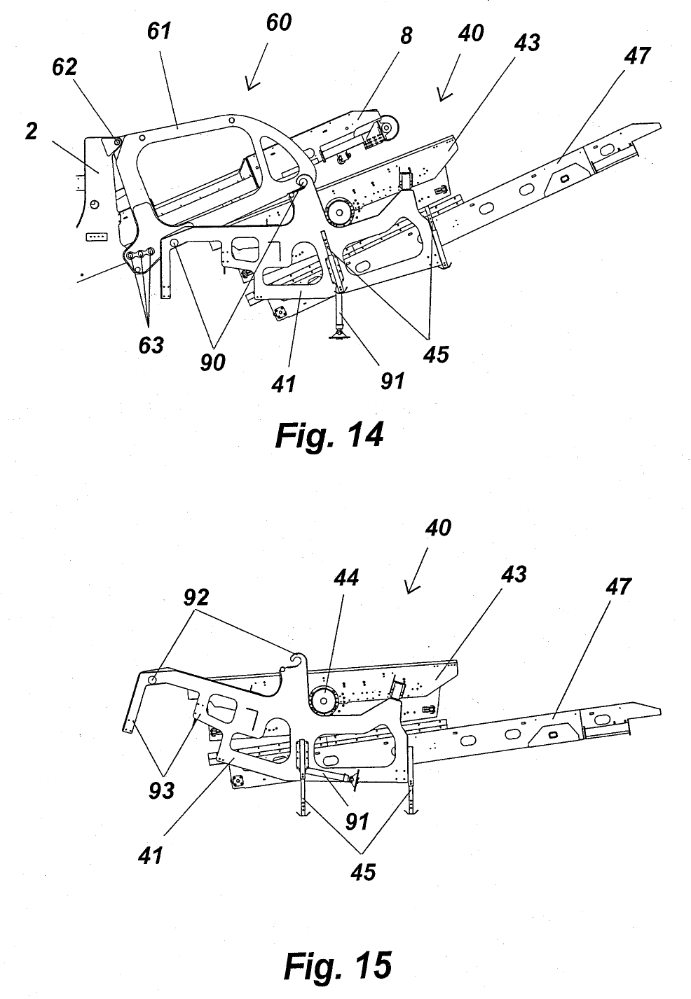

FIG. 14 shows a side view of a multi-purpose fastening device 60 of a movable processing device of mineral materials in accordance with the present invention equipped with a sieving module 40, in its upper position.

The multi-purpose fastening device 60 is now equipped with means 90 for attaching the sieving module 40. When the processing device 1 of mineral material is in its operating position, the multi-purpose fastening device has the sieving module supported on the means 90. The support legs of the sieving module 40, attached movably to the frame 41 of the sieving module, are driven to their upper position. Instead of these, the sieving module is supported to the ground by an operating support leg 91 having a variable length and being exactly adjustable according to the form of the ground. In this way, the loading exerted by the sieving module 40 to the main frame 2 can be significantly decreased. With the operating support leg 91, the support leg 46 of the main frame, known from the solutions of prior art, can be replaced, whereby also this change of the main frame, usually required by the additional sieving module 40, is unnecessary.

Preferably there are at least two operating support legs 91, at least one on each side of the device 1, viewed from the front or from the back of the device. Advantageously the length of the operating support leg 91 is hydraulically adjustable and preferably the support leg is driven by the own hydraulic system of the device 1 and controlled by the own control system of the device 1.

It can be seen in FIG. 15, how the sieving module 40 in accordance with FIG. 4 is detachably attached to the main frame 2, and how in the situations, where the processing of mineral materials does not require the use of the sieving module 40, the sieving module can be left, detached from the processing device 1 of mineral materials, standing supported by its own support legs 45. By means of the attaching means 90 of the sieving module and the corresponding attaching means 92 of the multi-purpose fastening device in the sieving module, the sieving module 40 can be detached from the processing device 1 of mineral materials and attached back thereto, when needed, easily, quickly and safely.

Preferably the support legs 45 and the operating support leg 91 are attached movably or detachably to the frame 41 of the sieving module, for example equipped with hinges or telescopes.

As already becoming evident from the descriptions of the embodiments of the present invention, the attaching means 64, 64′, 71, 71′, 90 of the multi-purpose fastening device 60 for attaching different accessory instruments to the multi-purpose fastening device 60, as well as the corresponding attaching means in the different accessory instruments 8, 20, 70, 80, 40 can be quite different. In the embodiment in accordance with FIGS. 14 and 15 one or a plurality of attaching means 90, 92 forms a crook or a loop, to which the axle or stud acting as the corresponding other attaching means is set. Because the multi-purpose fastening means 60 is movable around the attaching means 62 with respect to the main frame 2, it is clear, that especially this kind of a pair of attaching means is especially suitable for quick attachment of the accessory instruments to the multi-purpose fastening device, and for quick detachment, respectively.

It should be appreciated, that the axle or the stud to set to the crook or the loop is preferably securable immobile with respect to the crook or loop, so that no accidental loosening of accessory instruments can occur.

For the purpose of simplifying the description, the side conveyor of the sieving module 40 is not shown in FIGS. 14 and 15, but it is evident for those skilled in the art, that the sieving module preferably also includes a side conveyor, said figures showing the required means 93 for attaching it.

The attachment of the movable processing device 1 of mineral materials safely to the sieving module 40 is provided so, that when the multi-purpose fastening device is in its lower position, the processing device 1 of mineral materials is moved to the vicinity of the sieving module 40 so, that the means 90 for attaching the sieving module and the means 92 for attaching the multi-purpose fastening device set close to each other, and they are locked together. After that, the supporting framework 61 of the multi-purpose fastening device 60 is turned with respect to the main frame 2 into its upper position so, that the support legs 45 of the sieving module are loosened from the ground. After that, the support legs 45 can be readjusted with respect to the frame 41 of the sieving module so, that they do not hamper during the operation of the sieving module. In case the supporting framework 61 of the multi-purpose fastening device 60 is not yet turned enough with respect to the main frame 2, to achieve the actual working position of the multi-purpose fastening device 60, the turning can be continued until the working position is achieved, and the supporting framework can be locked substantially immobile with respect to the main frame. Now, when the operating support leg 91 is adjusted to support the frame 41 of the sieving module to the ground, and the operating support leg is locked substantially immobile with respect to the frame 41 of the sieving module, the safe use of the sieving module can be started. Naturally, the sieving module can be safely detached from the processing device of mineral materials by taking the above-mentioned measures in the opposite order.

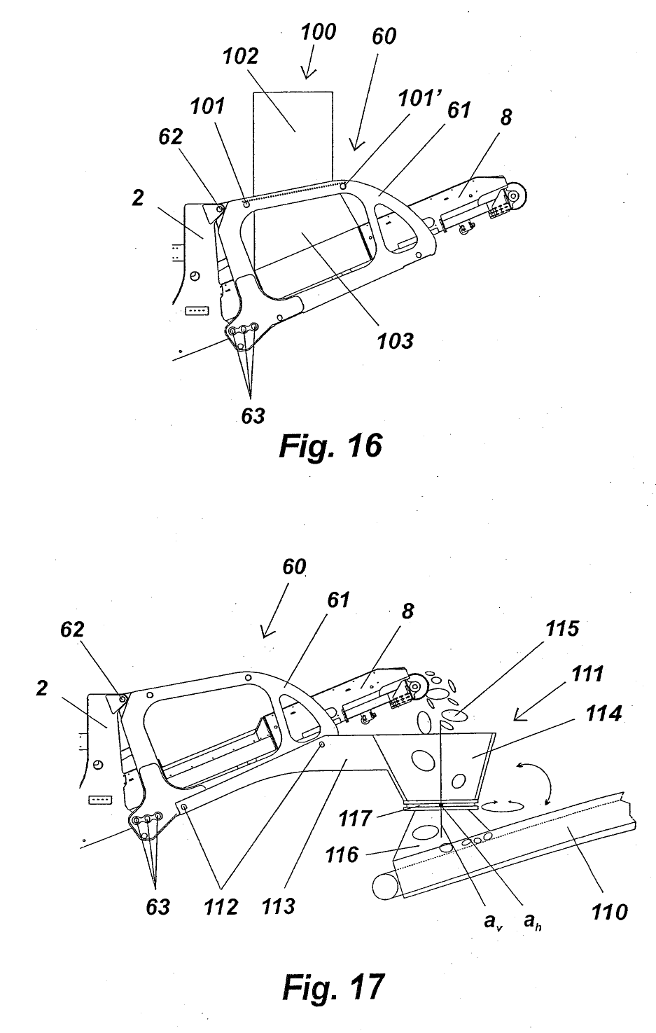

FIG. 16 shows the multi-purpose fastening device 60 of a movable processing device of mineral materials 1 in accordance with the present invention equipped with a dust removal device 100. In this embodiment of the invention, means 101, 101′ for attaching the dust removal device are formed to the supporting framework 61 of the multi-purpose fastening device 60. In the figure, the dust removal device 100 itself, is of a model known in the art, comprising a suction part 102, where the mineral material dust rising from the conveyor 8 is guided to by means of a funnel 103. The dust is collected to a container (not shown), which is in connection with the suction part 102 of the dust removal device.

In the corresponding way, also other solutions known in the art for suppressing the dust from the processed mineral material can be attached to the multi-purpose fastening device in accordance with the invention. This can be provided for example by attaching water pipes or a nozzle or nozzles to the multi-purpose fastening device, for suppressing the dust by spraying water onto the processed mineral material on the conveyor 8.

Again, the attaching means 101, 101′ can include many kinds of attachments known in the art, for example of the kind described above with reference numbers 64, 64′, 71, 71′, 90, 92.

FIG. 17 shows a multi-purpose fastening device of a movable processing device of mineral materials in accordance with the present invention equipped with another kind of an additional conveyor or a conveyor chain 110. In this embodiment of the invention, a bracket 111 for the starting additional conveyor or conveyor chain 110 is attached to the multi-purpose fastening device. The bracket 111 is formed in this case substantially of two parts, a frame part 113 and a hopper part 114. The function of the hopper part 114 is to guide the processed mineral material 115 from the conveyor 8 to the starting end of the additional conveyor or conveyor chain 110 to be transferred with the additional conveyor or conveyor chain further off from the processing device of mineral materials. Attaching means are formed to the frame part 113 for attaching the bracket 111 to the attaching means 112 formed to the supporting framework 61 of the multi-purpose fastening device.

The additional conveyor or the conveyor chain 110 is attached at its starting end to the bracket 111 below the hopper part 114 thereof, so that the additional conveyor or conveyor chain 110 hangs from the bracket supported by the attaching means 116 via hinge 117. The hinge 117 is formed so as to allow the turning of the additional conveyor or conveyor chain 110 on the horizontal level about the vertical axis av of the hinge 117 with respect to the bracket 111 and the main frame 2 of the processing device 1 of mineral materials. In addition, the hinge 117 allows the turning of the additional conveyor or conveyor chain 110 on the vertical level with respect to the bracket 111 and the main frame 2 of the processing device 1 of mineral materials, about the horizontal axis ah transversal to the additional conveyor or conveyor chain 110.

Preferably the discharge end of the additional conveyor 110 rests on the ground supported by wheels and the means 116 for attaching the starting end of the additional conveyor to the bracket 111 are rigid, so that the additional conveyor can be transferred together with the processing device of mineral materials. If the additional conveyor 110 forms a part of the conveyor chain 110, in which the discharge end of the previous conveyor and the starting end of the following conveyor are joined at the joining point to each other, at least the joining points of the conveyor chain and eventually also the discharge end of the last conveyor of the chain, rest preferably on the ground supported by wheels, and the means 116 for attaching the front end of the additional conveyor to the bracket are rigid, so that the joint points or the whole conveyor chain can be transferred together with the processing device of mineral materials.

Again, the attaching means 112 can include many kinds of attachments known in the art, for example as those described above with reference numbers 64, 64′, 71, 71′, 90, 92, 101, 101′. All said attaching means can be different from each other, but preferably they are standardized so that several different accessory instruments can be attached to one and the same attachments of the multi-purpose fastening device, when it is not necessary or not possible to attach them simultaneously to the multi-purpose fastening device.

It should be appreciated, that the form of the multi-purpose fastening device 60 or the mode of attachment thereof to the main frame 2 are not limited to the embodiments described with reference to the drawings. For example the means 62 for attaching the supporting framework to the main frame, turnably with respect to the main frame, is in all embodiments shown in the figures located in the upper part of the main frame, and the supporting framework, and the means 63 for locking the supporting framework to the main frame substantially immobile with respect to the main frame is in all embodiments shown in the figures located in the lower part of the main frame and the supporting framework. Naturally also the reverse solution is included in the scope of the invention. Likewise, the means 65 for turning the supporting framework with respect to the main frame can be implemented located in some other way or with different means without departing from the scope of the invention.

The invention is not limited to any certain processing method of mineral materials. Although the movable processing device of mineral materials is exemplified in the detailed description of the invention by a track-supported, self-propelled crushing device, it is clear for those skilled in the art, that also devices processing mineral materials in other ways are within the scope of the invention, like for example screening devices. Further, it is clear that the invention is not limited to any certain transportation technique of the device, but in addition to the track-supported, self-propelled device, also devices transferable with any other methods, like wheel supported, towed devices, are within the scope of the invention.

Further, the invention is not limited to any certain material to be processed, but it also covers the applications, where the device for processing mineral materials processes any other material, than the mineral materials processed most usually by the devices meant for processing mineral materials, like stone, gravel, ores, bricks, concrete, asphalt etc.

It is evident for those skilled in the art, that along with the development of the technique, the basic idea of the invention can be implemented in many different ways. Thus, the invention and its embodiments are not limited to the examples described above, but they can vary within the scope of the claims.

1. A frame of a movable processing device of mineral materials for supporting processing means of mineral materials, said frame comprising means for transferring the processing device of mineral materials, wherein the frame comprises a main frame and a multi-purpose fastening device attached turnably to the front end of the main frame, said multi-purpose fastening device being equipped with means for attaching detachably different accessory instruments of the processing device of mineral materials.

2. Frame in accordance with claim 1, wherein the frame comprises means for turning the multi-purpose fastening device with respect to the main frame.

3. A frame in accordance with claim 1, wherein the frame comprises means for locking the multi-purpose fastening device in place with respect to the main frame.

4. A frame in accordance with claim 1, wherein the multi-purpose fastening device is attached to the main frame at least with one hinge.

5. A frame in accordance with claim 2, wherein the means for turning the multi-purpose fastening device with respect to the main frame comprises a hydraulic cylinder.

6. A multi-purpose fastening device formed in the front end of the main frame of a movable processing device of mineral materials, wherein the multi-purpose fastening device is attached turnably to the main frame and it can be locked substantially immobile with respect to the main frame, said multi-purpose fastening device being arranged to implement at least two of the following operations:
attachment and support of the discharge end of the discharge conveyor with respect to the main frame,
adjustment of the angle of elevation of the discharge conveyor,
attachment and support of the additional conveyor of the discharge conveyor with respect to the main frame,
attachment and support of the sieving module with respect to the main frame,
additional supporting of the conveyors of the sieving module with respect to the main frame,
attachment and support of the tow bar with respect to the main frame,
attachment and support of the magnet separator with respect to the main frame,
attachment and support of the dust removal or dust suppression apparatus with respect to the main frame, and
attachment and support of the movable conveyor chain with respect to the main frame.

7. A multi-purpose fastening device in accordance with claim 6, wherein it comprises a supporting framework.

8. A multi-purpose fastening device in accordance with claim 6, wherein it comprises means for locking the multi-purpose fastening device at least in two different positions with respect to the main frame.
